(19) United States
(12) Patent Application Publication
(10) Pub. No.: US 2011/0121138 A1
(43) Pub. Date: May 26, 2011

(54) LOW PAYLOAD WEIGHT PARACHUTE RELEASE-AWAY STATIC LINE

(75) Inventors: Dennis J. Walsh, Brooklyn, NY (US); Philip McManus, Miami, FL (US)

(73) Assignee: Atair Aerospace, Inc., Brooklyn, NY (US)

(21) Appl. No.: 12/842,742

(22) Filed: Jul. 23, 2010

Related U.S. Application Data
(60) Provisional application No. 61/228,329, filed on Jul. 24, 2009.

(51) Int. Cl. B64D 17/52; B64D 17/60; B64D 17/64; B64D 17/58

(52) U.S. Cl. 244/149

(57) ABSTRACT

A system and method of deploying a parachute system, wherein the system functions with a timed delay or without a timed delay. The system can include a primary static line and a release-away line, wherein the primary static line is connected to a main chute and also to a soft link. The soft link can be cut by a cutter, thereby releasing the parachute system from an aircraft. Alternatively, the primary static line may contain a cable, wherein the cable features a three or more loop assembly that allows for release of the primary static line from the aircraft. The system may also utilize a three ring assembly or other mechanical actuation device. The system may include a drogue chute as well as a main chute.

### CROSS-REFERENCE TO RELATED APPLICATIONS

This application claims priority from U.S. Provisional Patent Application No. 61/228,329 filed Jul. 24, 2009 and incorporated fully herein by reference.

### TECHNICAL FIELD

The present invention relates to the deployment of parachutes by static line and more particularly, relates to the use of various release-away lines to allow for release of the static line from the aircraft following the departure of the parachute from an aircraft.

### BACKGROUND INFORMATION

When deploying parachutes by static line for personnel and cargo use, it is common practice for the static line, usually 15 feet in length, to be attached to a permanently installed anchor line cable or permanently affixed attachment point inside the aircraft using a metal static line snap hook attached to one end of the static line. Once the jumper or cargo is hooked up to the aircraft anchor line cable and exits the aircraft, the static line elongates breaking an initial securing tie or pins which close the container the parachute is housed in. This then deploys the parachute suspension lines and parachute canopy, either round, rectangular or other shape. The action and purpose of the static line is to allow the deployment of the parachute rapidly upon cargo or jumper departure through no action of jumper or other automatic actuating device. In such applications the static line remains attached to the aircraft anchor line cable with a certain majority length remaining outside and towing behind the aircraft once the jumpers or cargo parachute has deployed.

It is a regular occurrence, both in military and civilian applications that multiple jumpers or cargo payloads exit from the same door or aircraft ramp using the same anchor line. The result of this method of dispatch is numerous static lines remaining towed behind the aircraft as additional jumpers exit, thus creating a hazardous situation whereby additional jumpers might be struck by or snagged by the previously deployed static lines; snagging applies equally to cargo. This may occur up until personnel on board the aircraft can retrieve the deployed static lines back inside the aircraft once the last jumper or payload has exited. To alleviate this problem, a release away static line was developed, patent number unknown, National Stock Number NSN 1670-01-487-5461 and is currently in the military inventory. However, the release away static line in current use has a minimum suspended payload weight (believed to be approximately 80 pounds) and a minimum aircraft forward speed (believed to be approximately 80 knots) indicated airspeed.

There are numerous evolving requirements for a release away static line deployed parachute when dropping lower payload weights, some as low as 10 pounds from a variety of aircraft to include unmanned aerial vehicles. Due to dispatch vehicle configuration desiring maximum aerodynamic performance and minimum aerodynamic interference, benefit is derived through the use of a release away static line. The release away static line currently in use within the military cannot, by design, satisfy these requirements.

Slow flying Unmanned Aerial Vehicles (UAV's) using bomb bay or under wing payload deployment methods are rapidly evolving but are restricted by the detrimental aerodynamic effect a deployed static line would have on the aircrafts flight surfaces and flight characteristics. In one such instance, a deployed static line from a bomb bay would require the opening of a compartment door or hatch, firstly, initiating unnecessary or undesired aerodynamic effect. Then, once the parachute is deployed, the additional drag caused by the static line exacerbates the effect the open bomb bay or payload compartment door initially creates. The deployed static line then has the unwelcome opportunity to interfere with aircraft control surfaces, (elevators, ailerons or other protrusions), causing added interference with the vehicles flight control. With no one remaining inside the aircraft to retrieve the deployed static lines and the absence of a mechanical retrieval device due to weight restriction considerations, the payload compartment door cannot be closed when the static line remains outside and towed behind the aircraft.

One approach to this problem is to use a parachute system which has incorporated the use of a small drogue parachute which is deployed immediately from a deployment pouch which could be directly attached inside the upper limit of a bomb bay type compartment. The size of the deployment pouch would be nominally smaller than any compartment delivering even the most minimal payload, allowing the pouch to remain inside the compartment, and thus allowing the closure of the compartment after dispatch. The size of the drogue or pilot parachute and thus drogue pouch is only limited to the size of the compartment to be deployed from, provided a hatch could be closed upon dispatch. However, this method does not account for an under wing deployment method which would cause the pouch to remain outside the aircraft, still causing aerodynamic impedance, albeit a reduced one. However, the effect of such additional drag caused by a towed static line or drogue pouch on aerial vehicles of frequently small size is exaggerated. This invention also maintains an option to solve this problem.

### SUMMARY

The present invention features a parachute system that utilizes a release away line. In one embodiment of the present invention, the parachute system comprises a primary static line and a release-away line, wherein the release away line is longitudinally movably located within the primary static line, and wherein the primary static line comprises an upper end loop connecting the primary static line to a first end of a soft link and a lower end loop connecting the primary static line to a parachute bag bridle; a cutter having a main body and one or more cutting surfaces, wherein the soft link is routed through the main body of the cutter and below the one or more cutting surfaces; and a snap hook having a soft link routing region and an aircraft attachment point attachment region, said aircraft attachment point attachment region of said snap hook configured for attaching to an aircraft attachment point, wherein a second end of the soft link is routed through the soft link routing region of said snap hook, and wherein in a first condition, said soft link couples the primary static line to the snap hook and wherein in a second condition, after being cut by the one or more cutting surfaces of said cutter, said soft link releases said primary static line from coupling to said snap hook.

The system may also include a drogue chute located inbetween the main chute and the release-away line. The snap hook of the system may be attached to a separable static line snap hook adapter. The aircraft attachment point may be located on an aircraft anchor line. The release of a payload from an aircraft triggers the cutting of the soft link and a release of the primary static line from an aircraft anchor line cable. The lower end loop of the primary static line is girth hitched to the bag bridle of the main chute. The main chute may include one or more of the following, an autonomous guidance unit and a payload.

The system may be used by way of the following method, comprising the acts of releasing the main chute from an aircraft, which releases the primary static line and allows an opening force to be absorbed by the primary static line; and releasing the main chute from a deployment bag, which causes pull pressure on the release-away line causing the release-away line to be drawn down through the primary static line, which then pulls down on the cutter thereby cutting the soft link with the one or more cutting surfaces of the cutter.

“In this embodiment, once the static line is fully elongated, the pilot or drogue parachute pouch is pulled from its temporary attachment location on the container of the system and immediately begins elongating the pilot or drogue parachute bridle. Once the static line and pilot or drogue parachute bridle is completely elongated it comes to an abrupt halt caused by the retarding action of the mechanically actuated drogue fall assembly, normally a three ring assembly^{patented}. This halt instantly causes the transfer of deployment force up from the three ring assembly, to the pilot parachute bridle, to the pilot or drogue parachute apex up through the drogue pilot parachute pouch, where the pilot parachute apex is attached to the static line internal release line. This force then pulls down on the internal release line, pulling the cutter down which sears the Spectra™ soft link. Once this takes place, the static line is free of the aircraft and is towed above the deployed pilot or drogue parachute while in timed delay. Once the mechanical delay device is actuated, the parachute systems three ring assembly, or other restraining mechanism is released, allowing the continued elongation of the pilot or drogue parachute bridle. This continued elongation pulls the closing pin(s) or breaks a low tensile strength container closing tie and pulls the parachute from the container to complete a standard double bagged static line deployment sequence. The drag caused by the drogue or pilot parachute will begin to defeat the suspension lines stowed with rubber bands. Once the last suspension line locking stow is released, the inner deployment bag is pulled from the outer deployment bag. The internal non collapsible drogue parachute and drogue slider control line then elongate to full extent. The final two drogue slider control line inner deployment bag locking stows are released and the parachute begins to come out of the inner deployment bag and pressurize. If used, the collapsible pilot parachute will perform its collapsing function once the internal non collapsible drogue parachute is elongated and pulls down on the first stage collapsible pilot parachutes' own internal “kill” line. The static line will continue to trail behind the pilot parachute and bridle while the primary parachute is fully opened The highest tensile/breaking strength in this entire sequence is the Spectra™ 1000 soft link, which absorbs all of the deployment restrictive force throughout the entire sequence. This entire deployment sequence is usually concluded within 3 seconds. Only the chosen static line hardware remains attached to the aircraft anchor line cable or attachment point.”

In another embodiment of the present invention, the parachute system comprises a primary static line; a cable that runs through the primary static line and attaches to a main chute; and a three or more loop assembly, wherein the three or more loop assembly is held together by the cable, which runs through a first loop of the three or more loop assembly.

The system may further include a drogue chute located inbetween the main chute and the cable. The snap hook of the system may be attached to a separable static line snap hook adapter and the primary static line. The main chute may include one or more of the following, an autonomous guidance unit and a payload.

The system of this embodiment may be used by way of the following acts: releasing the main chute from an aircraft, which releases the primary static line and allows an opening force to be absorbed by the primary static line; releasing the main chute from a deployment bag, which causes pull pressure on the cable, which draws the cable downward toward the main chute; and allowing the cable to be pulled passed the three or more loop assembly, which releases the three or more loop assembly thereby allowing the primary static line to fall free from the aircraft.

In this method, the system may further comprise a three ring assembly or other mechanically actuated drogue fall assembly attached to the main chute; and a mechanical delay device. The method may provide for only the snap hook and an upper release away tab to remain attached to the aircraft anchor line or attachment point after release of the three or more loop assembly.

The method may further comprise the acts of releasing the drogue chute from an aircraft thereby causing elongation of the primary static line and drogue bridle, which causes an abrupt halt thereby transferring deployment force up to the three ring assembly and up to the pilot or drogue parachute apex up through the drogue pilot parachute pouch, where the pilot parachute apex is attached to the static line internal release line. This force then pulls down on the internal release line, pulling the cable down through the two or more loop assembly. Once this takes place, the static line is free of the aircraft and is towed above the deployed pilot or drogue parachute while in timed delay.

In another embodiment of the present invention, the parachute system comprises a primary static line comprising an upper end loop connecting the primary static line to a soft link and a lower end loop connecting the primary static line to a bridle loop located on an outer deployment bag; a release-away line located within the primary static line, wherein the release-away line is routed through a grommet located on the outer deployment bag and then attached to an apex of a pilot or drogue chute; and a drogue slider control line attached to the pilot or drogue chute, which is routed through a canopy of a main chute and then attached to a parachute slider.

This embodiment of the present invention may further feature a soft link routed through the upper end loop of the primary static line; a cutter with a main body and one or more cutting surfaces, wherein the soft link is further routed through the main body of the cutter below the one or more cutting surfaces; and a snap hook attachable at an aircraft attachment point, wherein the soft link is further routed through the snap hook.

The method of using this system comprises the acts of: allowing the parachute system to leave an aircraft, thereby pulling an inner deployment bag from the outer deployment bag and initiating an elongation of the drogue slider control line, which removes a chute from the inner deployment bag and causes pull pressure on the release-away line thereby drawing the release-away line down through the primary static line, which pulls the cutter causing cutting of the soft link by the one or more cutting surfaces.

In yet another embodiment of the present invention, the release-away line is not used, but rather is temporarily stowed into a spandex sleeve sewn near both ends of the primary static line and wherein the system further includes a three ring assembly that temporarily restrains the main chute by mechanical means and allows for a mechanical release during a drogue fall sequence.

In this embodiment, the method of using the system comprises the following acts: deploying the parachute system using the mechanical release during a drogue fall sequence, thereby allowing full elongation of the drogue or pilot chute and causing release of the main chute from the three ring assembly.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a detailed view of a low weight release away static line used with a double bag static line configuration of one embodiment the present invention;

FIG. 2 is a detailed view of a low weight release away static line when using a three ring drogue option of one embodiment the present invention;

FIG. 3A is a detailed view of a cutter and FIG. 3B is a detailed view of a static line of one embodiment the present invention;

FIG. 4 is a detailed view of a spandex sleeve of one embodiment of the present invention;

FIG. 5 is a detailed view of a low weight release away static line using a direct bag option of one embodiment of the present invention; and

FIG. 6 is a low weight release away static line using a three ring drogue option of one embodiment the present invention.

### DETAILED DESCRIPTION OF THE PREFERRED EMBODIMENTS

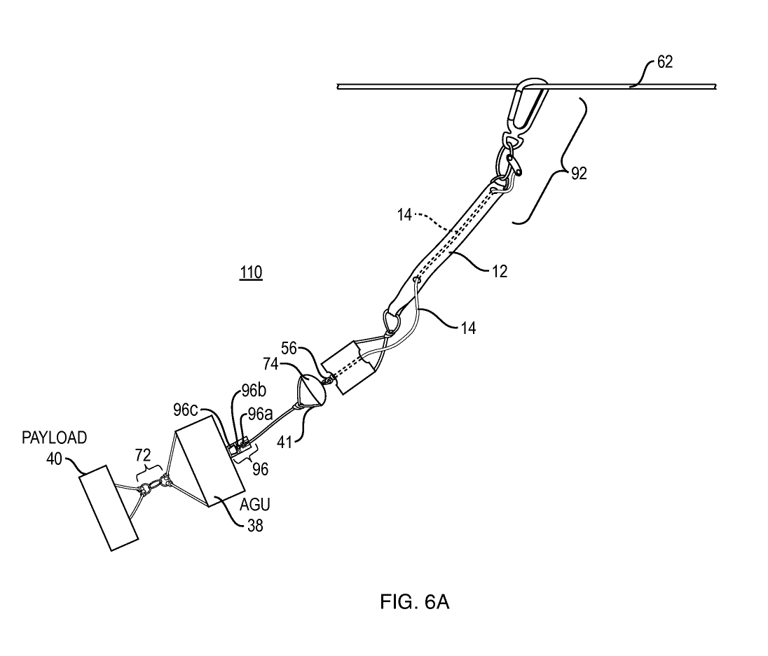

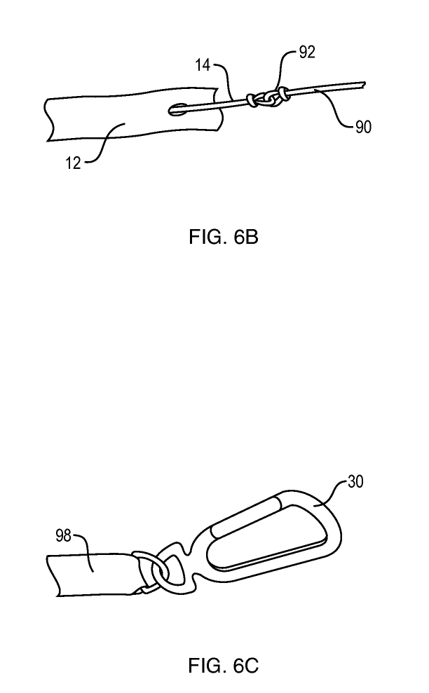

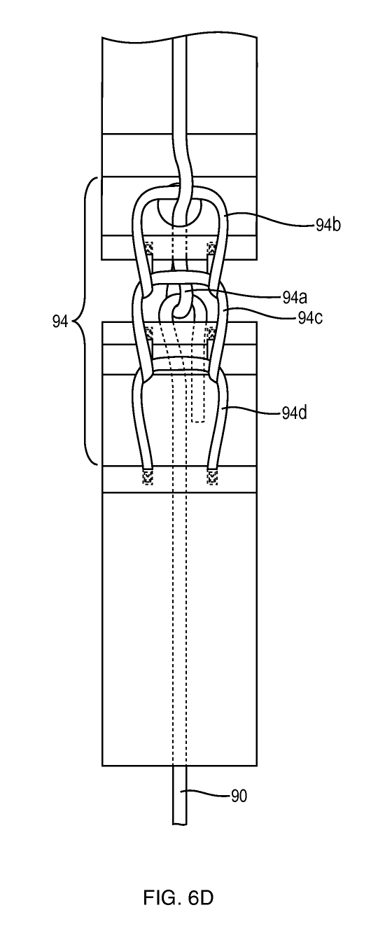

The description provided here will be with reference to guided and unguided cargo parachute systems (10), but it is understood that the invention applies equally well to personnel use and higher suspended weights, since weight does not impede function. Two versions named Version/Option A (10) and Version/Option B (110, FIG. 6) are hereby submitted. It is necessary for the submission of the two variants in order to accommodate user needs or preference. The overall performance function of both variants remains the same, and as such is appropriately submitted in union.

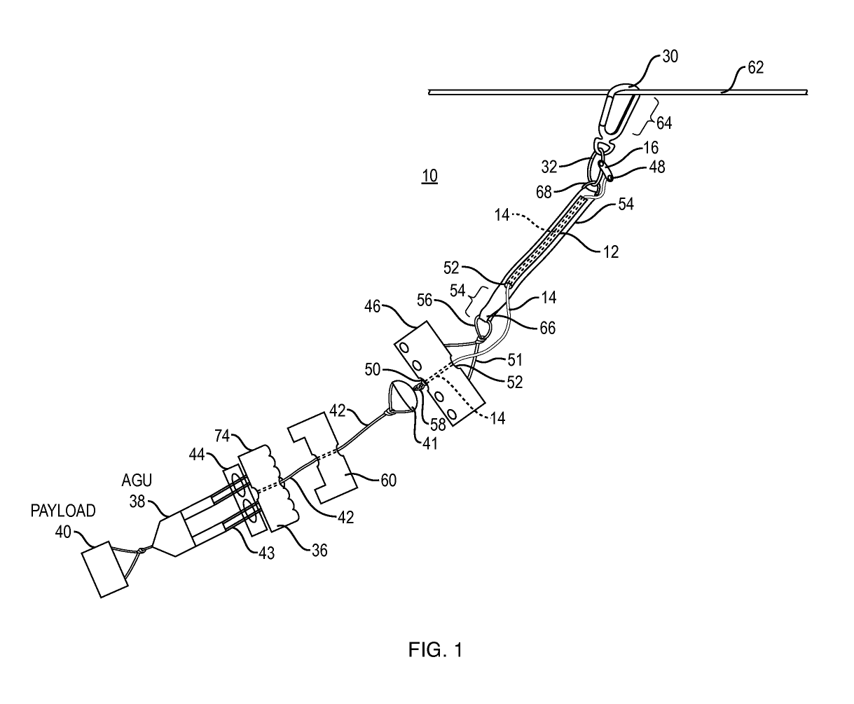

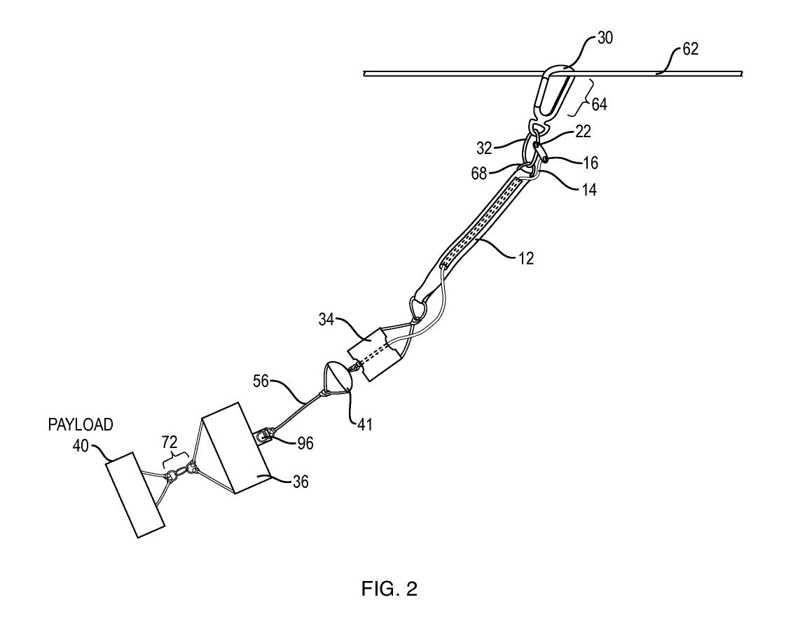

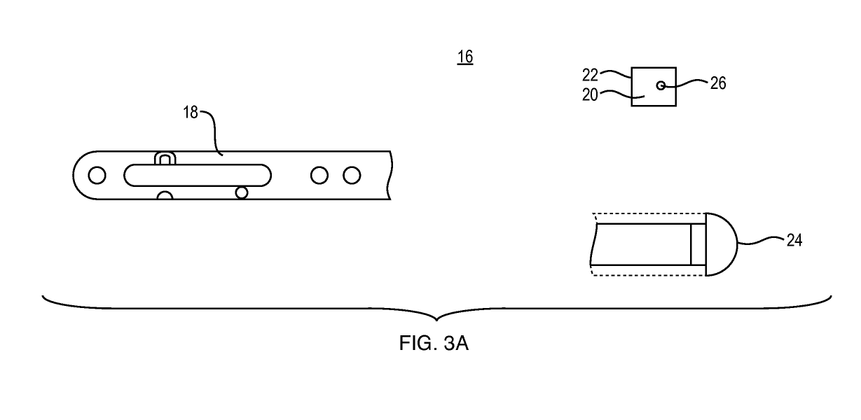

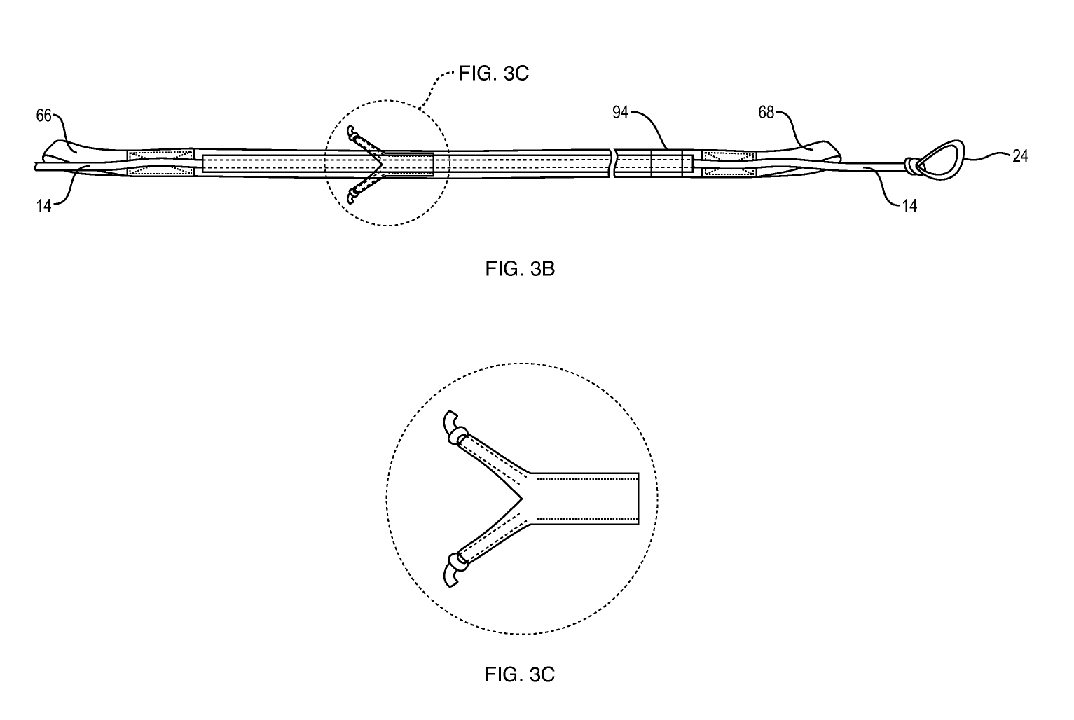

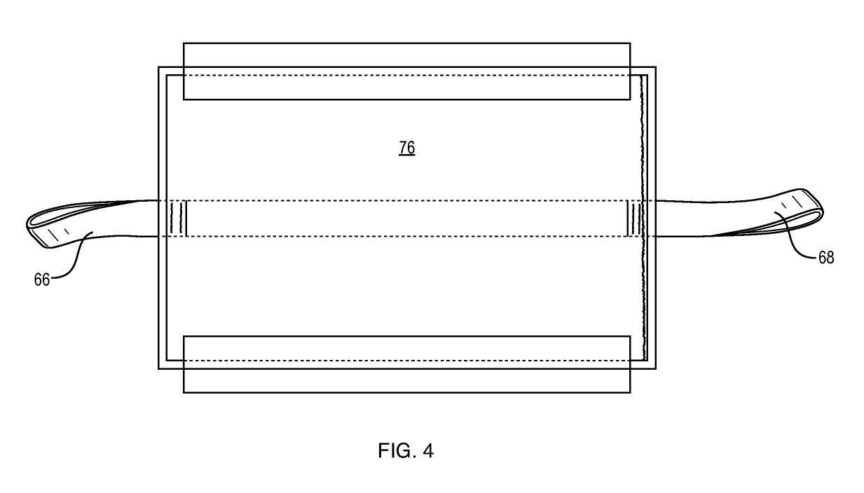

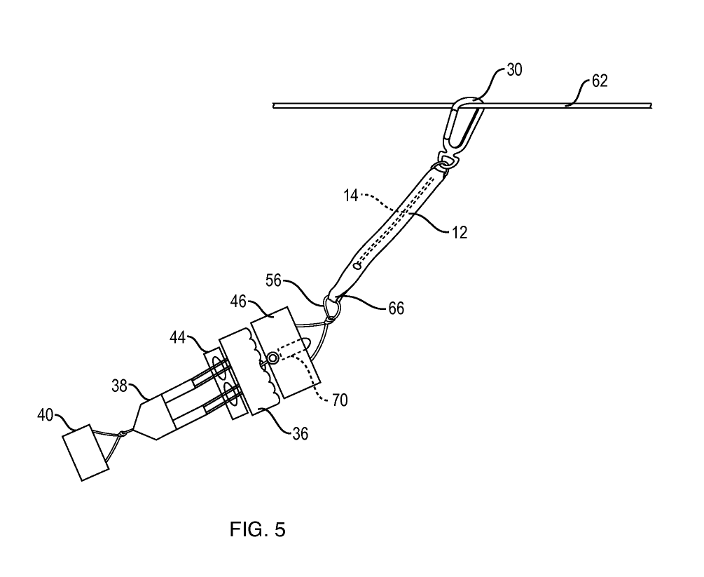

Version A of the low weight static line parachute system (10) is modular and comprises seven separable components and is shown generally in FIGS. 1-5. The primary static line (112), is generally Yellow, or another color and is preferably a one (1″) inch wide type XVII nylon webbing, Mil-W-4088, tensile strength 2500 pounds. This material is in common use in the parachute industry. The release-away line (14), is generally white/natural or another color and is preferably made of Spectra™ 500. This material is in common use in the parachute industry and normally used for parachute suspension lines. The cutter (16), is generally gun metal blue or another color and generally is comprised of at least 6 parts; main body (18), knife set sleeve (20), two size 11 X-Acto Blades™ or another suitable cutting surface (22), one end cap (24), and one knife retention spring pin (26). A separable static line snap hook adapter serves as a snap hook 30. The snap hook may be made from one (1″) inch wide type XVII nylon webbing, Mil-W-4088, with a tensile strength of 2500 pounds. The Static line hardware is based on one of the following options (only one is required). Option 1: A Snap Hook, static line part number MS 70120^{patented}; in common use in the parachute industry and military organizations. Option 2: A Universal Static Line Snap Hook part number MS 81337^{patented}, in common use in the parachute industry and military organizations in the United States. Option 3: Clevis, small part number PS70086-2^{patented}; in common use in the parachute industry and military organizations. Each option is shown generally as the snap hook 30 in the figures. A Five inch soft link, which is preferably made from a material such as Spectra™ 1000. This part is expendable and will need to be replaced after each deployment. Finally, a drogue deployment pouch. The drogue deployment pouch includes the following components: flexible woven fabric/Spandex™, Cordura™ 500, 420 denier pack cloth, one inch wide type IV reinforcing tape, ¾″ wide type III ribbon weave binding tape, one inch wide type XVII nylon webbing. This part is optional when using the drogue parachute delayed deployment method.

Version B of the low weight static line parachute system (110) according to the invention is modular consisting of six separable components and is shown generally in FIG. 6. A primary static line (12), which can be Yellow, or another color, and is generally one (1″) inch wide, type XVII nylon webbing, Mil-W-4088, tensile strength 2500 pounds. This material is in common use in the parachute industry. There are two separable parts in this version. A release-away line (14), which may be white/natural or another color and is generally made from a material such as Spectra™ 500. This material is in common use in the parachute industry and normally used for parachute suspension lines. A Yellow plastic encased 1/16″ diameter aircraft cable (90) with a crimped loop (92) in its end. A Separable Static line Snap Hook Adapter (28) for snap hook, part number MS 70120. The Separable Static line Snap Hook Adapter can be made from a material such as a one (1″) inch wide type XVII nylon webbing, Mil-W-4088, tensile strength 2500 pounds. The Static line hardware can be any one of the following options, and only one is required. Option 1: Snap Hook, static line part number MS 70120^{patented}; in common use in the parachute industry and military organizations: or Option 2: Universal Static Line Snap Hook part number MS 81337^{patented}, in common use in the parachute industry and military organizations in the United States; or Option 3: Clevis, small part number PS70086-2^{patented}; in common use in the parachute industry and military organizations. These three options are shown generally in the figures as snap hook (30). A Drogue Deployment Pouch (34) is made from materials that are flexible such as woven fabric/Spandex™, Cordura™ 500, 420 denier pack cloth. one inch wide type IV reinforcing tape, ¾″ wide type III ribbon weave binding tape, one inch wide type XVII nylon webbing. The drogue deployment pouch is optional when using the drogue parachute delayed deployment method.

There are two general static line deployment methods in use in the parachuting and military community today. One is the single bag (sometimes referred to as direct bag; terms used interchangeably) or double bag static line deployment method, wherein the static line immediately pulls the parachute from the closed container upon exiting the aircraft. The second is a method wherein a drogue parachute is used. The drogue parachute being deployed from a small drogue pouch immediately upon leaving the aircraft. The drogue parachute quickly inflates and stabilizes the payload, then, through mechanical means, the drogue parachute is released from its temporary attachment point on the parachute system following a timed or altitude controlled delay. Both versions of the invention herein submitted satisfy all of the above mentioned deployment strategies while creating a release away capability for the static line in both instances.

Except where indicated, the following descriptions provided apply equally to version A (10) and version B (110) of the present invention. The ultimate function of either device remains the same, which is to allow the release of the static line (12) from the aircraft anchor line cable (62) or attachment point (64) made possible through the drag force of a payload/parachute (40) departing an aircraft (not shown). The difference between the two is the method and material in which the static line (12) releases from the aircraft anchor line cable (62) or aircraft attachment point (64).

When a parachute system is configured in the direct bag or double bag configuration (FIGS. 1-5), the lower end loop (66) of the static line (12) is girth hitched to the deployment bags static line attachment bridle (51/56), which is permanently sewn to the deployment bag (46) centered on the bottom. The attachment bridle features an upper portion of the bridle (56) and a lower portion of the bridle (51). Directly underneath this permanently sewn deployment bag bridle (51/56) there exists a hole made by a grommet (52). This grommet is normally an industry standard size number four nickel grommet, commonplace on parachute deployment bags on civilian sport and military personnel parachute systems. One of the chief reasons for this hole in the first place is to serve as a portal to connect an industry standard collapsible pilot parachute “kill” line or release-away line (14) to a permanently sewn ring (58) located on the top center of the pilot chute canopy proper. In the case of the collapsible pilot parachute, the pilot parachute (41) pulls the parachute (36) from the deployment bag (60) following a container closing pin extraction, since the pilot parachute bridle sheath is permanently affixed to the deployment bag by a bag stop or girth hitch. The drag the pilot parachute (41) generates exceeds the retarding strength of any temporarily stowed component of the packed parachute. Essentially the release away static line (14) performs a similar function and may take advantage of such currently existing equipment.

The release away static line (14) can be used for single bag or direct bag static line deployment when a timed delay is not required and the release away function is desired. When using a single bag static line deployment method when no timed delay is desired, it is the static line which opens the container by either pulling a pin(s) or breaking a temporary container closing tie immediately upon system dispatch. This deployment method is desirable at the lowest altitudes and slowest airspeeds due to rapid parachute deployment. This method is sometimes called “direct bag” method. This is the most rapid method of static line deployment.

In the case of either release away static line herein submitted when used in the direct bag static line deployment configuration, the lower end of the static line is first girth hitched (50) to the deployment bag static line attachment bridle loop (56). The release away static line (14) internal actuation line, sometimes also referred to as a “kill” line, is then routed through the deployment bag grommet (52) and attached to the permanently sewn ring (58) attached near the top center of the pilot parachute canopy proper, normally using a small number 3.5 barrel nut link, but this not restrictive. In the case of round parachute utilization, the release away static line (14) would be attached to what is referred to as an apex loop (58) on the top center of the parachute canopy (41). These parachute manufacturing configurations are current and commonplace, thereby allowing the release away static line to readily take advantage of them.

When properly rigged, a five inch Spectra™ 1000 soft link (32) is routed through the upper end of the static line loop (68), then through the open body (18) of the aluminum cutter (16) below the knives or cutting surface (22), then through the chosen static line snap hook hardware (30). Once the parachute (36) leaves the aircraft, the static line (12) is pulled from its' temporary stows, usually rubber bands, elongates, then either extracts a closing pin (s) sewn to the static line which temporarily close the packed parachute container, or break a low tensile strength closing tie (not shown). Once out of the container, the parachute (36) still housed in the deployment bag (60), begins to allow the parachute suspension lines (43) to elongate, since all of the opening force is still being absorbed by the static line (12) attached to the permanently sewn deployment bag bridle loop (56). The suspension lines (43) are stowed and retained by rubber bands, which are easily defeated by the restricting effect of the aircraft anchor line cable (62)—to static line (112)—to deployment bag (46). No force has yet been placed on the static line internal release away line (14), since the parachute (36) is still in the deployment bag (46) until the last deployment bag suspension line locking stows (not shown) are pulled free through inertia and drag.

Once the last suspension line locking stows are freed through elongation, the parachute begins to come out of the bag. Once the parachute is out of the bag, pull pressure begins to occur on the internal release away line (14) due its attachment to the sewn top ring (58) of the canopy. This pulling action of the static line internal release away actuation line (14), draws it down through the permanently sewn channel which is on one side of the static line. This then, pulls down on the cutter (16), which has been attached to the internal release away line top end (68), closest to the aircraft. The function of version A is replaced with version B here if version B is used. When the internal release away line (14) pulls down on the cutter (16) far enough, it cuts through the Spectra™ 1000 soft link (32) which has been routed through the cutter body (18) below the knives or cutting surface (22), allowing the entire static line (12), less the chosen hardware (30) to fall free from the aircraft. Only the chosen hardware (a minimal amount, as little as only the snap hook (30)) remains attached to the aircraft anchor line cable (62) or aircraft attachment point (64).

In the case of version B (110) all previous actions remain the same until: “ . . . when the internal release away line (14) pulls down on the yellow plastic encased cable (90), the yellow cable (90) is drawn downward toward the load (40), once the cable end is pulled passed the soft loop assembly (94), the loop assembly (typically comprised of two or more loops and preferably three or more loops) releases, allowing the entire static line (12), less the chosen hardware, to fall free from the aircraft. Only the chosen hardware and upper release away tab (98) remain attached to the aircraft anchor line cable (62) or aircraft attachment point (64).”

When using a double bag static line deployment method when no timed delay is desired, it is the static line which opens the container by either pulling a pin(s) or breaking a temporary container closing tie immediately upon system dispatch (not shown). This deployment method is desirable at the low or extremely high altitudes at higher true air speeds when the parachute deployment speed needs to be regulated in order to mitigate the possibility of canopy or parachute system damage, yet, no mechanical delay or opening device is desired.

The double bag static line deployment method is roughly similar to the single or direct bag static line deployment method. In the case of the release away static line (14) herein submitted when used in the double bag static line deployment configuration as shown in FIG. 1, the lower end of the static line is first girth hitched to the outer deployment bag (46) static line attachment bridle loop (56). The release away static line internal actuation line(14), sometimes also referred to as a “kill” line, is then routed through the outer deployment bag grommet (52) and attached to the apex of the collapsible or non collapsible pilot or drogue parachute (41) respectively. The drogue or pilot parachute (41) is attached to a drogue slider control line (42) which is routed through the center of a rectangular canopy (60) and in turn attached to the parachute slider (44); this regulates canopy pressurization due to the drag created by the drogue or pilot parachute (41).

When properly rigged, a five inch Spectra™ 1000 soft link (32) is routed through the upper end of the static line loop (68), then through the open body (18) of the aluminum cutter (16) below the knives or cutting surface (22), then through the chosen static line snap hook hardware (30). Once the parachute leaves the aircraft, the static line (12) is pulled from its' temporary stows, usually rubber bands, elongates, then either extracts a closing pin (s) sewn to the static line which temporarily closes the packed parachute container, or break a low tensile strength closing tie (not shown). Once out of the container, the parachute still housed in the inner and outer deployment bag (60 and 46), begins to allow the parachute suspension lines (43) to elongate, since all of the opening force is still being absorbed by the static line attached to the permanently sewn deployment bag bridle loop (56) on the outer bag (46). The suspension lines (43) are stowed and retained by rubber bands, which are easily defeated by the restricting effect of the aircraft anchor line cable (62)—to static line (12)—to deployment bag (46). No force has yet been placed on the static line internal release away line (14), since the parachute is still in the deployment bag (60/46) until the last deployment bag suspension line locking stows are pulled free through inertia and drag.

Once the last suspension line locking stows are freed from the outer bag (46) through elongation, the inner deployment bag (60) is pulled from the outer bag (46) initiating the elongation of the drogue slider control line (42). Once the drogue slider control line (42) reaches its final two inner deployment bag locking stows, the parachute begins to come out of the bag. Once the parachute is out of the bag, pull pressure begins to occur on the internal release away line (14) due its attachment to the drogue (41) and drogue slider control line (42) down through the packed canopy (74). This resistant pulling action of the drogue slider control line (42) up through the static line internal release away actuation line (14), draws the release line (14) down through the permanently sewn channel which is on one side of the static line (12). This then, pulls down on the cutter (16), which has been attached to the internal release away line top end (48) closest to the aircraft. When the internal release away line (14) pulls down on the cutter (16) far enough, it cuts through the Spectra™ 1000 soft link (32) which has been routed through the cutter body (18) below the knives or cutting surface (22), allowing the entire static line (12), less the chosen hardware (30) to fall free from the aircraft. Only the chosen hardware (30) remains attached to the aircraft anchor line cable (62) or aircraft attachment point (64).

In the case of version B (110) all previous actions remain the same until: “ . . . when the internal release away line (14) pulls down on the yellow plastic encased cable (90), the yellow cable (90) is drawn downward toward the load (40), once the cable end is pulled passed the soft loop assembly (94), typically comprised of two or more loops and preferably three or more loops. The loop assembly (94) releases, allowing the entire static line (12), less the chosen hardware to fall free from the aircraft. Only the chosen hardware and upper release away tab (98) remains attached to the aircraft anchor line cable (62) or attachment point (64).”

The Release Away Static line (14) is configured for use with a drogue or collapsible pilot parachute (41) in single bag or double bag configuration when timed delay is required and release away function is desired. When using a single bag static line deployment method when a timed delay is desired, it is the drogue or pilot parachute bridle (56) which opens the container by either pulling a pin(s) sewn to it or breaking a temporary container closing tie immediately upon actuation of the drogue delay release mechanism (not shown). This single deployment bag method is generally desirable for situations where a timed delay is needed due to high altitude dispatch yet a rapid canopy opening is desired following controlled drogue fall delay where the possibility of canopy damage from opening force is minimal. This deployment option is most useful when an extremely high dispatch altitude and extremely low deployment altitude is required. Additionally, this method is desirable when the release away static line function is required. This deployment method is the most rapid of the time delayed option.

This invention may be used, and will perform its release away function for applications when a timed delay is required, while using a non collapsible drogue parachute or when a collapsible pilot parachute is desired. When used with either a drogue or collapsible pilot parachute (41) in this way, the pilot parachute or drogue parachute bridle (56) must be secured to the deployment bag (46) through the use of a girth hitch or standard bag stop (not shown). The apex (58) of the pilot parachute must be attached to the static line release away line (14) up through the drogue parachute pouch (34). This is done using either a 5″ Spectra™ soft link (32) or small hardware such as a 3.5 barrel nut link (not shown). When configured in this manner, the static line (12) elongates first upon aircraft exit. Once the static line (12) is fully elongated, it pulls the pilot or drogue parachute pouch (34) from its temporary attachment location on the container of the system and immediately begins elongating the pilot or drogue parachute bridle (56). Once the static line (12) and pilot or drogue parachute bridle (56) is completely elongated it comes to an abrupt halt caused by the retarding action of the mechanically actuated drogue fall assembly, normally a three ring assembly (96). This halt instantly causes the transfer of deployment force up from the three ring assembly, to the pilot parachute bridle (56), to the pilot or drogue parachute apex up through the drogue pilot parachute pouch (34), where the pilot parachute apex is attached to the static line internal release line (14). This force then pulls down on the internal release line (14), pulling the cutter (16) down which sears the Spectra™ soft link (32). Once this takes place, the static line (12) is free of the aircraft and is towed above the deployed pilot or drogue parachute (41) while in timed delay. Once the mechanical delay device is actuated, the parachute systems three ring assembly (96), or other restraining mechanism is released, allowing the continued elongation of the pilot or drogue parachute bridle (56). This continued elongation pulls the closing pin(s) or breaks a low tensile strength container closing tie and pulls the parachute from the container to complete a standard single bag deployment sequence (not shown). If used, the collapsible pilot parachute will perform its collapsing function and the static line will continue to trail behind the pilot parachute and bridle while the primary parachute is fully open. Only the chosen hardware will remain attached to the aircraft anchor line cable (62) or aircraft attachment point (64).

In the case of version B all previous actions remain the same until: “ . . . this force then pulls down on the internal release away line (14) pulls down on the yellow plastic encased cable (90), the yellow cable (90) is drawn downward toward the load (40), once the cable end is pulled passed the soft loop assembly (94), (typically comprised of two or more loops and preferably three or more loops), the loop assembly (94) releases, allowing the entire static line (12), less the chosen hardware to fall free from the aircraft. Only the chosen hardware and upper release away tab (98) remains attached to the aircraft anchor line cable (62) or aircraft attachment point (64).”

When using a double bag static line deployment method when a timed delay is desired, it is the drogue or pilot parachute bridle (56) which opens the container by either pulling a pin(s) sewn to it or breaking a temporary container closing tie immediately upon actuation of the drogue delay release mechanism (not shown). This double deployment bag method is generally desirable for situations where a timed delay is needed due to extreme high altitude dispatch and extremely high parachute deployment altitudes following controlled drogue fall delay are needed when the possibility of canopy damage from opening force is high. Additionally, this method is desirable when the release away static line function is required. This deployment method is the slower of the two time delayed options.

A double bag static line configuration currently exists as general industry standard except without a timed delay with release away capability in either the high or low payload weight range. When used with either a drogue or collapsible pilot parachute (41) in this way, the pilot parachute or drogue parachute bridle (56) must be secured to the outer deployment bag (46) through the use of a girth hitch or standard bag stop (not shown). The apex of the drogue or pilot parachute (41) must be attached to the static line release away (14) line up through the drogue parachute pouch (34). This is done using either a 5″ Spectra™ soft link (32) or small hardware such as a 3.5 barrel nut link (not shown). When configured in this manner, the static line (12) elongates first upon aircraft exit.

Once the static line (12) is fully elongated, it pulls the pilot or drogue parachute pouch (34) from its temporary attachment location on the container of the system and immediately begins elongating the pilot or drogue parachute bridle (56). Once the static line and pilot or drogue parachute bridle (56) is completely elongated it comes to an abrupt halt caused by the retarding action of the mechanically actuated drogue fall assembly, normally a three ring assembly (96). This halt instantly causes the transfer of deployment force up from the three ring assembly (96), to the pilot parachute bridle (56), to the pilot or drogue parachute apex up through the drogue pilot parachute pouch (34), where the pilot parachute apex is attached to the static line internal release line (14). This force then pulls down on the internal release line (14), pulling the cutter (16) down which cuts the Spectra™ soft link (32). Once this takes place, the static line (12) is free of the aircraft and is towed above the deployed pilot or drogue parachute (41) while in timed delay.

Once the mechanical delay device is actuated, the parachute systems three ring assembly (96), or other restraining mechanism is released, allowing the continued elongation of the pilot or drogue parachute bridle (56). This continued elongation pulls the closing pin(s) or breaks a low tensile strength container closing tie and pulls the parachute from the container to complete a standard double bagged static line deployment sequence (not shown). The drag caused by the drogue or pilot parachute (41) will begin to defeat the suspension lines (43) stowed with rubber bands. Once the last suspension line locking stow is released, the inner deployment bag (60) is pulled from the outer deployment bag (46). The internal non collapsible drogue parachute (41) and drogue slider control line (42) then elongate to full extent. The final two drogue slider control line inner deployment bag locking stows are released and the parachute begins to come out of the inner deployment bag (60) and pressurize. If used, the collapsible pilot parachute (41) will perform its collapsing function once the internal non collapsible drogue parachute (41) is elongated and pulls down on the first stage collapsible pilot parachutes' own internal “kill” line. The static line (12) will continue to trail behind the pilot parachute and bridle while the primary parachute (36) is fully opened. The highest tensile/breaking strength in this entire sequence is the Spectra™ 1000 soft link (32), which absorbs all of the deployment restrictive force throughout the entire sequence. This entire deployment sequence is usually concluded within 3 seconds. Only the chosen static line hardware remains attached to the aircraft anchor line cable (62) or aircraft attachment point (64).

In the case of version B all previous actions remain the same until: “ . . . this force then pulls down on the internal release away line (14) pulls down on the yellow plastic encased cable (90), the yellow cable (90) is drawn downward toward the load 40), once the cable end is pulled passed the soft loop assembly (94), typically comprised of two or more loops and preferably three or more loops, the loop assembly (94) releases, allowing the entire static line (12), less the chosen hardware to fall free from the aircraft. Only the chosen hardware and upper release away tab (98) remains attached to the aircraft anchor line cable (62) or aircraft attachment point (64).”

The release away static line is configured for use with a drogue parachute or collapsible pilot parachute (41) when a timed delay is required and release away function is not desired. This invention may be used, but will not perform its release away function for applications when a timed delay is required. This method demonstrates further versatility and modularity of the invention regardless of release away function. This application is, in part, based upon the benefits of a single source static line performing all of the static line deployment methods in common use in the parachuting arena.

When used in this way, the static line lower end (66) is girth hitched to a small pilot parachute pouch (34), the internal release away line (14) is not used but temporarily tucked/stowed into a Spandex™ sleeve (76) sewn near both ends of the static line for later use. Although pilot parachute and pouch size are not limiting factors, they are second only in consideration of any desire to not have detrimental effect on aerodynamics by protruding from the vehicle after dispatch. The parachute is packed in the normal manner, in either single or double bag configuration, and the pilot parachute bridle is stowed as would be typical for this type of application. The pilot parachute must be temporarily restrained by mechanical means, normally a standard three ring assembly (96) with a mechanical release during its drogue fall sequence. When deployed from the aerial vehicle, the static line (12) fully elongates pulling the drogue (34) or pilot parachute (36) pouch from its temporary location on the parachute container. The drogue or pilot parachute (41) leaves the deployment pouch (34) girth hitched on the lower end of the static line (66) unrestricted. The pilot parachute inflates causing drag, placing the payload (40) in a face to Earth orientation and ultimately becomes the drag force which conducts the elongation of the suspension lines (43) and parachute once it is released by mechanical means. When the timed or altitude release mechanism initiates the pilot parachute is released from its temporary restraining device (three ring assembly (96)), then further elongates-quickly extracting the container closing pin(s) or low strength closing tie and pulling the parachute from the container (not shown). The drogue or pilot parachute drag then continues the parachute deployment sequence in the usual single or double bag manner. In this application, the entire static line and deployment pouch would remain outside the aerial vehicle.

In the case of version B the stowage of the static line internal kill line remain the same until: “ . . . the internal release away line (14) is not used but temporarily tucked/stowed into a Spandex™ sleeve sewn (not shown) near the lower end of the static line for later use. The soft loop assembly (94), typically comprised of two or more loops and preferably three or more loops, remains assembled with the yellow plastic encased cable (90) and continues to absorb the deployment forces.”

Modifications and substitutions by one of ordinary skill in the art are considered to be within the scope of the present invention, which is not to be limited except by the following claims.

1. A parachute system comprising:
a primary static line and a release-away line, wherein the release away line is longitudinally movably located within the primary static line, and wherein the primary static line comprises an upper end loop connecting the primary static line to a first end of a soft link and a lower end loop connecting the primary static line to a parachute bag bridle;
a cutter having a main body and one or more cutting surfaces, wherein the soft link is routed through the main body of the cutter and below the one or more cutting surfaces; and
a snap hook having a soft link routing region and an aircraft attachment point attachment region, said aircraft attachment point attachment region of said snap hook configured for attaching to an aircraft attachment point, wherein a second end of the soft link is routed through the soft link routing region of said snap hook, and wherein in a first condition, said soft link couples the primary static line to the snap hook and wherein in a second condition, after being cut by the one or more cutting surfaces of said cutter, said soft link releases said primary static line from coupling to said snap hook.

2. The system of claim 1, wherein the system further includes a drogue chute located inbetween the main chute and the release-away line.

3. The system of claim 1, wherein the snap hook is attached to a separable static line snap hook adapter.

4. The system of claim 1, wherein the aircraft attachment point is located on an aircraft anchor line.

5. The system of claim 1, wherein a release of payload from an aircraft triggers the cutting of the soft link and a release of the primary static line from an aircraft anchor line cable.

6. The system of claim 1, wherein the lower end loop of the primary static line is girth hitched to the bag bridle of the main chute.

7. The system of claim 1, wherein the main chute includes one or more of the following, an autonomous guidance unit and a payload.

8. The method of using the parachute system of claim 1, comprising the acts of:
releasing the main chute from an aircraft, which releases the primary static line and allows an opening force to be absorbed by the primary static line; and
releasing the main chute from a deployment bag, which causes pull pressure on the release-away line causing the release-away line to be drawn down through the primary static line, which then pulls down on the cutter thereby cutting the soft link with the one or more cutting surfaces of the cutter.

9. The system of claim 1, further comprising:
a three ring assembly or other mechanically actuated drogue fall assembly attached to the main chute; and
a mechanical delay device.

10. The method of using the parachute system of claim 9, comprising the acts of:
releasing the main chute from an aircraft thereby causing elongation of the primary static line, which pulls from the main chute and allows for elongation of the bag bridle; and
completely elongating the bag bridle which causes an abrupt halt, which transfers deployment force up to the three ring assembly, to the bag bridle and up to the release-away line, which causes a pulling down on the release-away line thereby causing the cutter to cut soft link, which frees the primary static line from the aircraft thereby releasing the three ring assembly and allowing continued elongation of the bag bridle.

11. A parachute system comprising:
a primary static line;
a cable that runs through the primary static line and attaches to a main chute; and
a three or more loop assembly, wherein the three or more loop assembly is held together by the cable, which runs through a first loop of the three or more loop assembly.

12. The system of claim 11, wherein the system further includes a drogue chute located inbetween the main chute and the cable.

13. The system of claim 11, wherein a snap hook is attached to a separable static line snap hook adapter and the primary static line.

14. The system of claim 11, wherein the main chute includes one or more of the following, an autonomous guidance unit and a payload.

15. The method of using the parachute system of claim 11, comprising the acts of:
releasing the main chute from an aircraft, which releases the primary static line and allows an opening force to be absorbed by the primary static line;
releasing the main chute from a deployment bag, which causes pull pressure on the cable, which draws the cable downward toward the main chute; and
allowing the cable to be pulled passed the three or more loop assembly, which releases the three or more loop assembly thereby allowing the primary static line to fall free from the aircraft.

16. The method of claim 15, wherein only the snap hook and an upper release away tab remain attached to the aircraft anchor line or attachment point after release of the three or more loop assembly.

17. The system of claim 11, further comprising:
a three ring assembly or other mechanically actuated drogue fall assembly attached to the main chute; and
a mechanical delay device.

18. The method of using the parachute system of claim 17, comprising the acts of:
releasing the main chute from an aircraft thereby causing elongation of the primary static line, which causes an abrupt halt thereby transferring deployment force up to the three ring assembly and up to the cable, and
activating the mechanical delay device to cause timed delay.

19. A parachute system comprising:
a primary static line comprising an upper end loop connecting the primary static line to a soft link and a lower end loop connecting the primary static line to a bridle loop located on an outer deployment bag;
a release-away line located within the primary static line, wherein the release-away line is routed through a grommet located on the outer deployment bag and then attached to an apex of a pilot or drogue chute; and
a drogue slider control line attached to the pilot or drogue chute, which is routed through a canopy of a main chute and then attached to a parachute slider.

20. The system of claim 19, further comprising:
a soft link routed through the upper end loop of the primary static line;
a cutter with a main body and one or more cutting surfaces, wherein the soft link is further routed through the main body of the cutter below the one or more cutting surfaces; and
a snap hook attachable at an aircraft attachment point, wherein the soft link is further routed through the snap hook.

21. The method of using the system of claim 19, further comprising the acts of:
allowing the parachute system to leave an aircraft, thereby pulling an inner deployment bag from the outer deployment bag and initiating an elongation of the drogue slider control line, which removes a chute from the inner deployment bag and causes pull pressure on the release-away line thereby drawing the release-away line down through the primary static line, which pulls the cutter causing cutting of the soft link by the one or more cutting surfaces.

22. The system of claim 19, wherein the release-away line is not used, but rather is temporarily stowed into a spandex sleeve sewn near both ends of the primary static line and wherein the system further includes a three ring assembly that temporarily restrains the main chute by mechanical means and allows for a mechanical release during a drogue fall sequence.

23. The method of using the system of claim 22, comprising the following acts:
deploying the parachute system using the mechanical release during a drogue fall sequence, thereby allowing full elongation of the drogue or pilot chute and causing release of the main chute from the three ring assembly.
